(19) United States
(12) Patent Application Publication
(10) Pub. No.: US 2024/0346369 A1
(43) Pub. Date: Oct. 17, 2024

(54) Automatic Feature Engineering for Machine Learning Pipelines

(71) Applicant: PayPal, Inc., San Jose, CA (US)

(72) Inventors: Gaurav Mukherjee, Dhanbad (IN); Lingxiao Wang, Shanghai (CN)

(21) Appl. No.: 18/315,741

(22) Filed: May 11, 2023

(30) Foreign Application Priority Data
Apr. 11, 2023 (WO) PCT/CN2023/087480

(51) Int. Cl. G06N 20/00

(52) U.S. Cl. CPC G06N 20/00

(57) ABSTRACT

Techniques are disclosed for updating an incremental cache with merged features generated by merging new, incremental features with the existing features. After retrieving source data including attributes from a source database, a system identifies, based on a known set of historical attributes included in the source data, new attributes in the source data. Using feature algorithms, the system generates new features from the new attributes. The system retrieves existing features from the incremental cache storing existing features generated from historical attributes in the source data. Using aggregation procedures, the system merges the new features and the existing features generated based on the historical attributes. Using the merged features, the system updates the incremental cache. The disclosed techniques may advantageously decrease time to retrieve a set of features e.g., for machine learning relative to traditional techniques that recalculate features from an entire source dataset when new source data is released.

The present application claims priority to PCT Appl. No. PCT/CN2023/087480, entitled “AUTOMATIC FEATURE ENGINEERING FOR MACHINE LEARNING PIPELINES”, filed Apr. 11, 2023, which is incorporated by reference herein in its entirety.

### BACKGROUND

### Technical Field

This disclosure relates generally to feature processing, and, more specifically, to techniques for generating features, for example, for use in machine learning training.

### Description of the Related Art

As more and more systems begin using machine learning to process big data, the features available to train machine learning models become more and more complex. In many situations, the machine learning models are trained on different types of features for a variety of different applications, such as analysis, risk detection, diagnostics, classification, pattern recognition, etc. In order to train on different types of data, different types of features may be generated prior to training machine learning models. Often, features are recalculated as new data is received. As such, training and updating machine learning models based on newly received data may be delayed while features are recalculated with new data. This in turn may delay or impair analyses performed by data processing systems utilizing the trained machine learning models due to the models being outdated (or updated models requiring extensive time and computing resources to train).

Many communication requests (one example of the data that may be processed) may be submitted with malicious intent, often resulting in wasted computer resources, network bandwidth, storage, CPU processing, etc. In this example, such computing resources may be wasted if the communications are processed based on inaccurate predictions performed by machine learning models that are outdated due to delays in the generation of features for training and updating these models. For example, an outdated machine learning model (which is outdated due to delays in feature generation) may inaccurately predict that a communication request is not suspicious, causing the communication to be processed (even though it is indeed suspicious) which often results in both computational and monetary loss.

### BRIEF DESCRIPTION OF THE DRAWINGS

FIG. 1A is a block diagram illustrating an example system configured to generate updated features by merging new and existing features, according to some embodiments.

FIG. 1B is a diagram illustrating example generation of updated, final features by merging new, incremental features and existing features, according to some embodiments.

FIGS. 2A and 2B are block diagrams illustrating example aggregation procedures executed by a merger module, according to some embodiments.

FIG. 3 is a block diagram illustrating example updating of feature tables stored in an incremental cache, according to some embodiments.

FIGS. 4A and 4B are block diagrams illustrating example feature requests, feature queries, query results, and responses for the feature requests, according to some embodiments.

FIG. 5 is a flow diagram illustrating an example method for generating updated features in response to a source dataset being updated, according to some embodiments.

FIGS. 6A and 6B are block diagrams illustrating example merged features generated based on a source dataset being updated, according to some embodiments.

FIG. 7 is a flow diagram illustrating a method for merging new and existing features and updating an incremental cache using merged features, according to some embodiments.

FIG. 8 is a block diagram illustrating an example computing device, according to some embodiments.

### DETAILED DESCRIPTION

As the processing bandwidth of different entities increases, retrieving and manipulating data for such entities (e.g., to generate complex features for use in training machine learning models) becomes increasingly time and resource-intensive. For example, some entities may accumulate and store source data with billions of attributes, with millions of new attributes being processed on a monthly, weekly, daily, etc. basis. As one specific example, an electronic communication processing system (e.g., PayPal™) may process communications for many different clients. In this specific example, a given client may initiate communications with millions of different users per day. In some situations, the slow processing of electronic communication data may lead to a poor user experience, loss of resources (e.g., both computational and financial), decrease in security (e.g., in situations in which attributes of the communication data are used to train machine learning models to identify suspicious activity in future communications), etc.

For example, when source data is being retrieved to generate features (e.g., for feature engineering purposes), if all stored historical source data is retrieved to generate summary features for use in machine learning and risk analysis, this feature processing will be time consuming, delaying risk analysis and, in turn, decreasing responsiveness to requested electronic communications (after analysis is complete). As one specific example, if electronic communication data is being retrieved for risk analysis, the time allowed for analysis of retrieved data may be limited by various service level agreements (SLAs) corresponding to different clients. For example, one client may have an SLA specifying that once a transaction has been initiated by a user, an authorization decision for this transaction must be generated within e.g., 150 milliseconds. As such, the types and extent of risk analyses able to be executed for transactions after such transactions are initiated is limited.

In disclosed techniques, an automated feature engineering system is executed to quickly generate and merge new features (based on new attributes included in source data) and existing features (previously generated from historical attributes included in source data). In contrast to traditional feature engineering processes, the disclosed retrieval and analysis of data may be performed much more quickly, since features generated from an entire set of source data do not need to be recalculated. Rather, the disclosed techniques calculate new, incremental features for only the new source data and merge these features with pre-existing features generated from large sets of historical source data. The disclosed incremental feature processing may advantageously improve the performance of feature calculation relative to traditional feature calculation techniques. For example, if source data for a given entity increases by 10% on a daily basis on average, then calculating features using the disclosed incremental techniques will be performed on this 10% of data instead of the entire data source, greatly decreasing the computational resources and time necessary to calculate features.

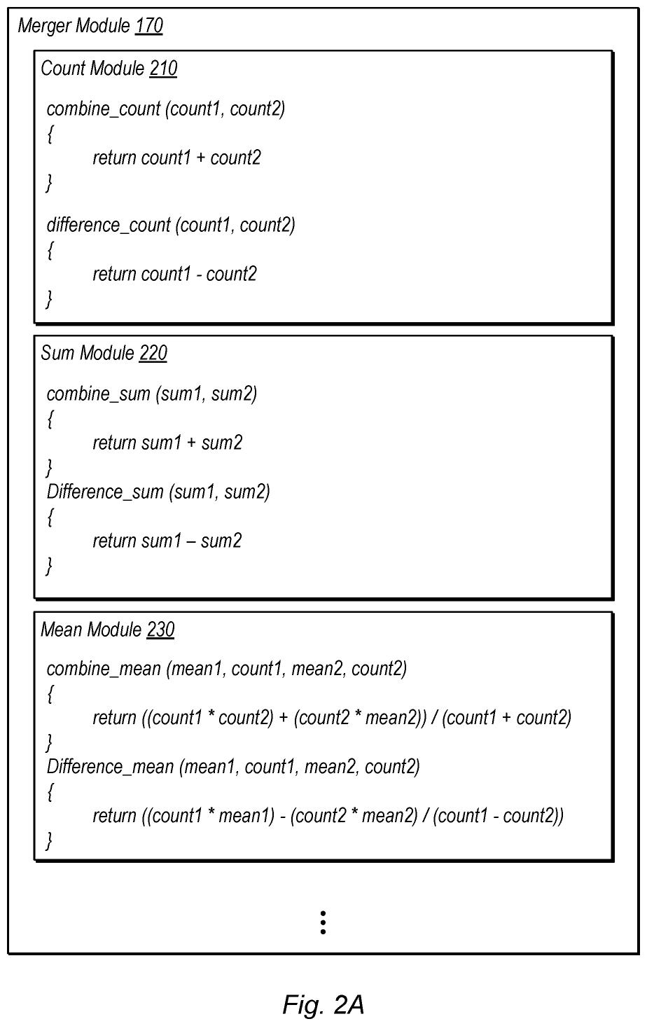

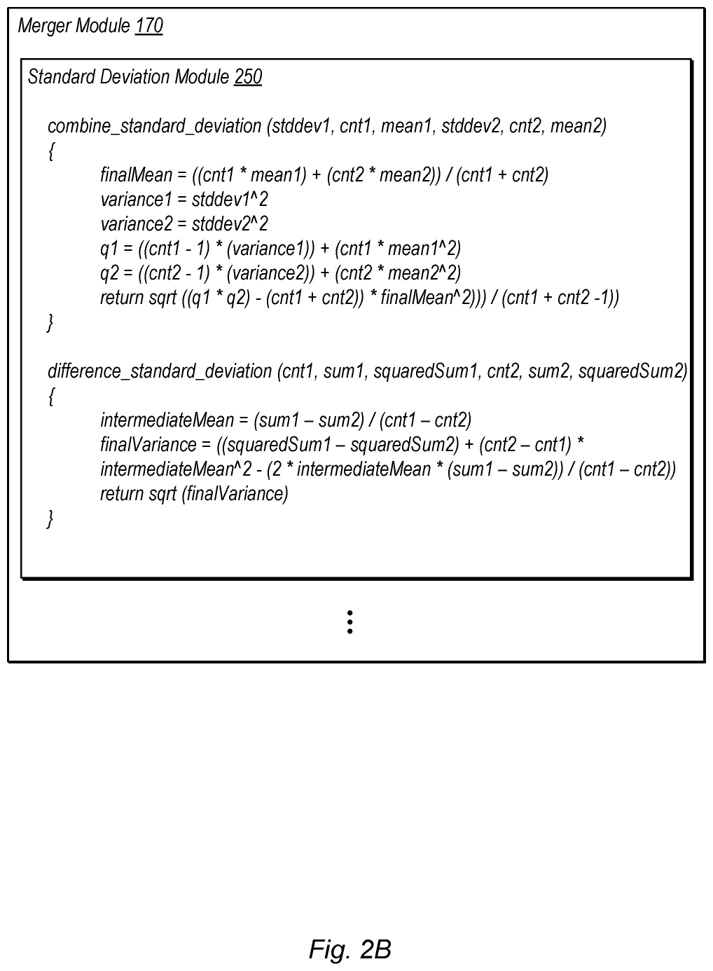

To combat the decrease in performance caused by recalculation of existing features when new source data is obtained, the disclosed techniques build an incremental cache for feature calculation and provide supplementary aggregation functions referred to herein as aggregation procedures to support incremental feature calculation and merging with existing features. As one specific example, suppose a feature that indicates the electronic communication count for a given user in the past six months is generated on Feb. 12, 2022 from electronic communication data from Aug. 12, 2021 to Feb. 12, 2022 for the given user. In this example, when another day passes and it is now Feb. 13, 2022, in order to calculate the feature that indicates the electronic communication count for the given customer from Aug. 13, 2021 to Feb. 13, 2022, feature engineering techniques would recalculate the feature using all of the data from Aug. 13, 2021 to Feb. 13, 2022. The disclosed techniques, however, calculate the electronic communication count for day Feb. 13, 2022 and then merge this count with the count previously calculated from Aug. 13, 2021 to Feb. 12, 2022. The disclosed techniques accomplish this merging of existing features and newly calculated features using a plurality of different customized aggregation procedures discussed in further detail below with reference to FIGS. 2A-6B.

A server system accomplishes the merging of existing features and newly calculated features by first identifying that new source data is available and has been stored in a source database. The identification of new data may be performed by comparing a set of historical attributes of the source data with a set of source data stored in a source database. After identifying that new data has been added to the source data, the disclosed system generates new features from the new data using one or more feature calculation algorithms and then calculates total, combined features by applying one or more aggregation procedures over source data attributes (e.g., count, sum, max, standard deviation, etc.) to merge existing features with newly calculated features.

In some situations, the disclosed system determines which sets of existing and new features to merge based on the unique keys of these features. For example, if an existing feature and a new feature have the same unique key, then the disclosed system will merge the two features. Further, in addition to merging existing and new features, the disclosed system may retrieve or calculate final features according to parameters specified in queries received from user computing devices. As one specific example, a user computing device may request a specified set of features with time limitations, and a feature accessor included in the disclosed system retrieves features and performs any necessary final calculations before transmitting the features to the user computing device e.g., for use in machine learning pipelines.

The disclosed techniques may advantageously provide for feature generation and retrieval that is independent of input (e.g., requests for features). For example, traditional feature calculation techniques calculate features relative to a particular timestamp. In disclosed techniques, however, as source data is updated, both incremental and merged features are pre-calculated and stored in an incremental cache whenever a source dataset changes (is updated or added to). As input (e.g., requests for features) is received, the disclosed techniques provide an exact feature output without the need to recalculate features. Further, the disclosed techniques prevent redundant feature calculation since, instead of recalculating features from an entire source dataset, the disclosed techniques calculate incremental features for new source data that is received and then merge the incremental features with existing features (calculated from historical source data) using the disclosed aggregation techniques to provide merged features. Still further, the disclosed incremental feature calculation and feature merging techniques advantageously provide for a one-time batch of all calculated features from a beginning time specified in the source data. For example, once these features are stored in the incremental database cache, these features are not limited by a historical time limitation as both incremental and merged features are available for historical time ranges as well as more recent time ranges.

The efficient generation and retrieval of features provided by the disclosed techniques may, in turn, advantageously allow for training and updating of machine learning models for use in predicting risk e.g., of various requested electronic communications. Such techniques may advantageously allow e.g., electronic communication processing systems to quickly analyze electronic communication data to identify suspicious behavior and, thereby, mitigate potential future suspicious (and potentially fraudulent) behavior. Such techniques may advantageously decrease the amount of computer resources necessary to perform feature queries as well as decreasing loss (e.g., financial, user trust, etc.) associated with suspicious electronic communications.

### Example Feature Generation System

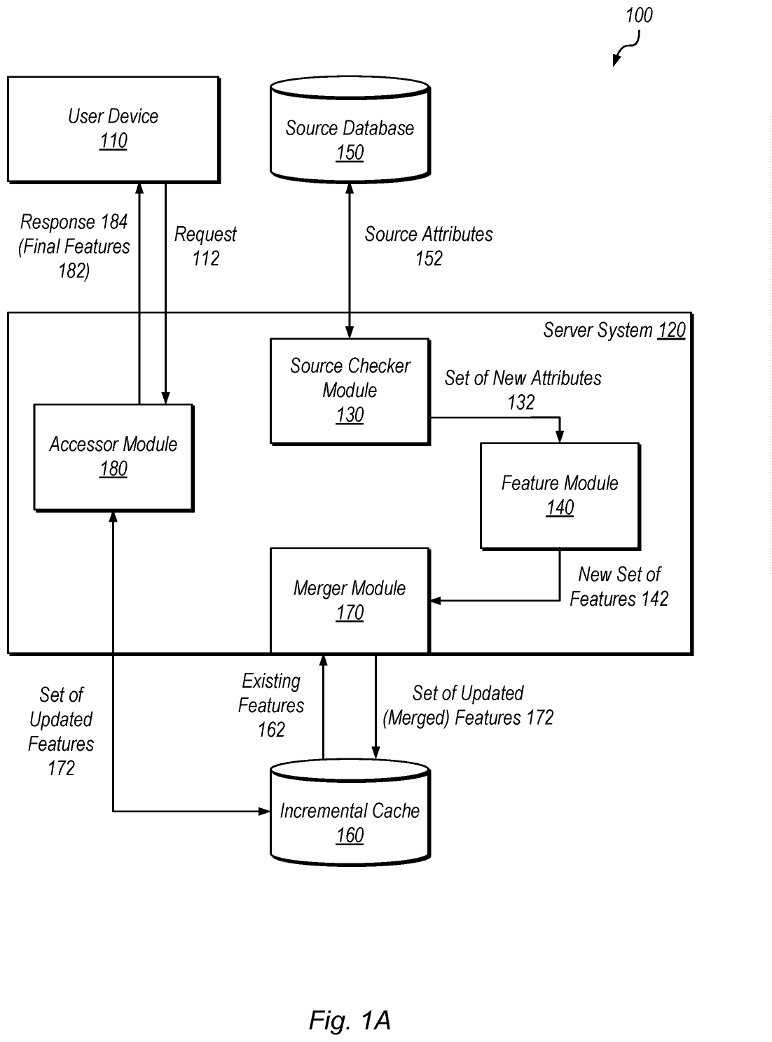

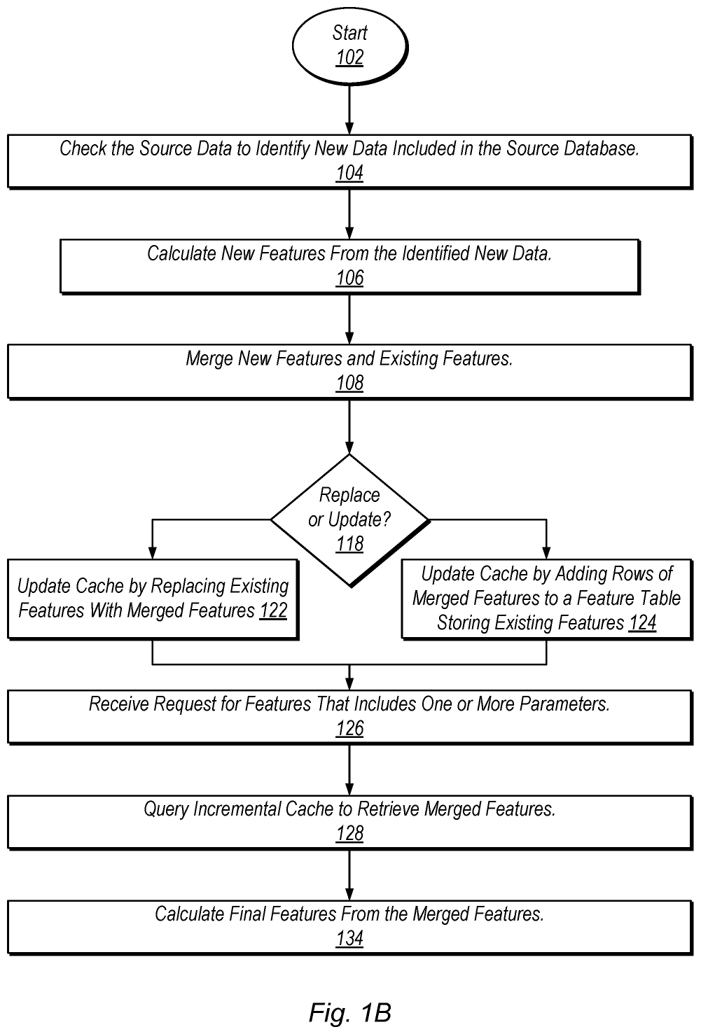

FIG. 1A is a block diagram illustrating an example system configured to generate updated features by merging new and existing features. In the illustrated embodiment, system 100 includes user device 110, source database 150, incremental cache 160, and server system 120, which in turn includes source checker module 130, feature module 140, merger module 170, and accessor module 180.

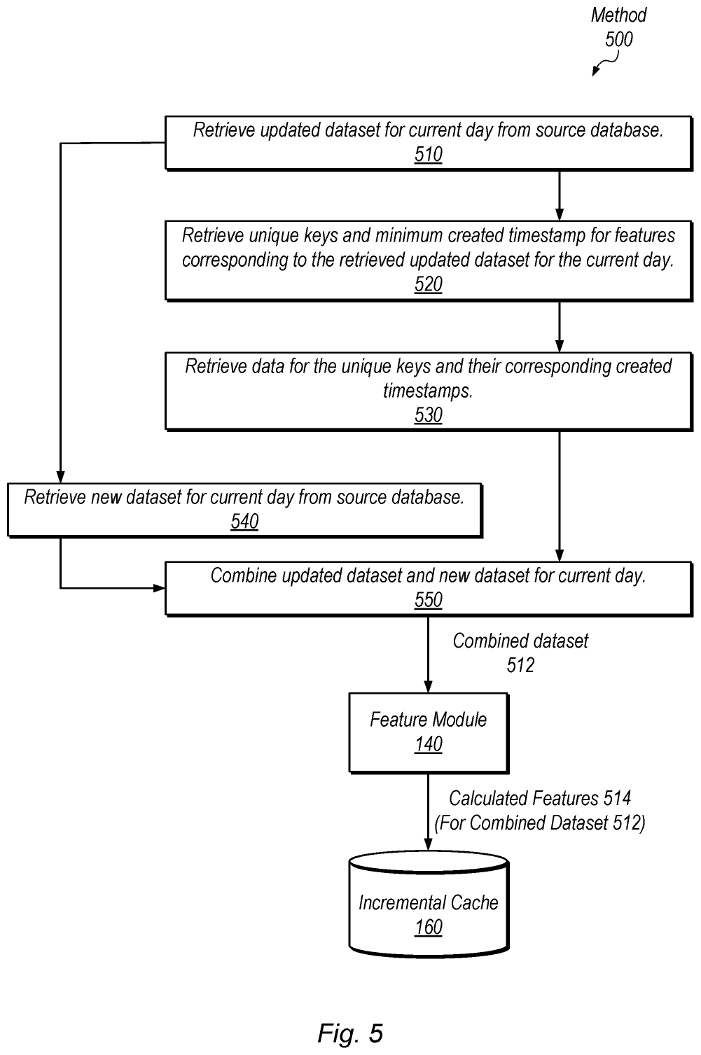

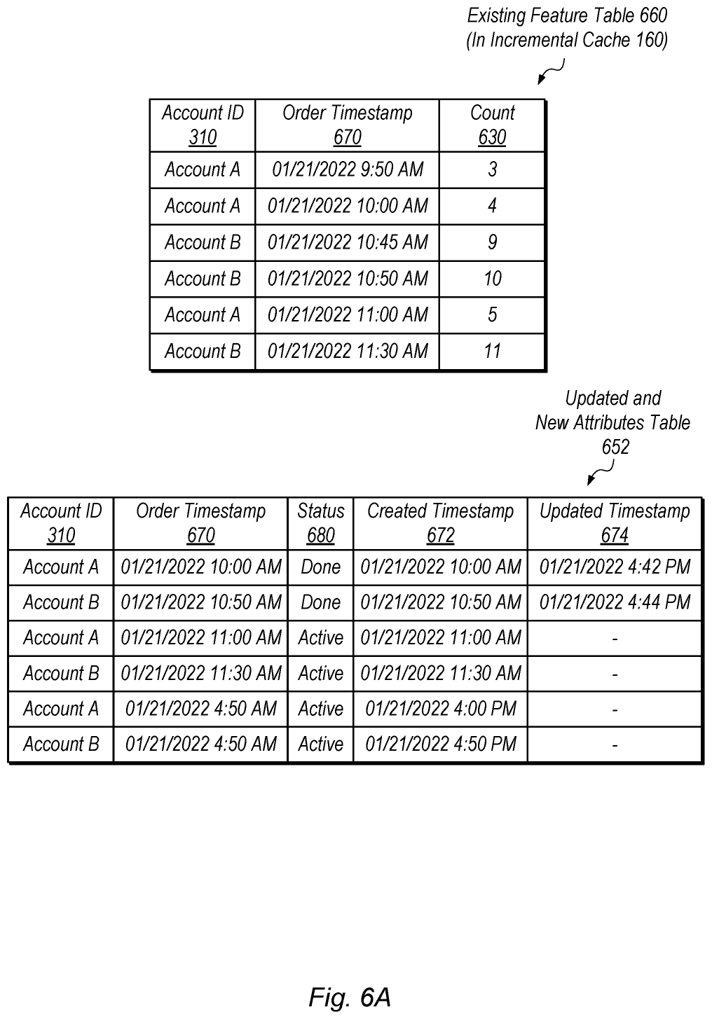

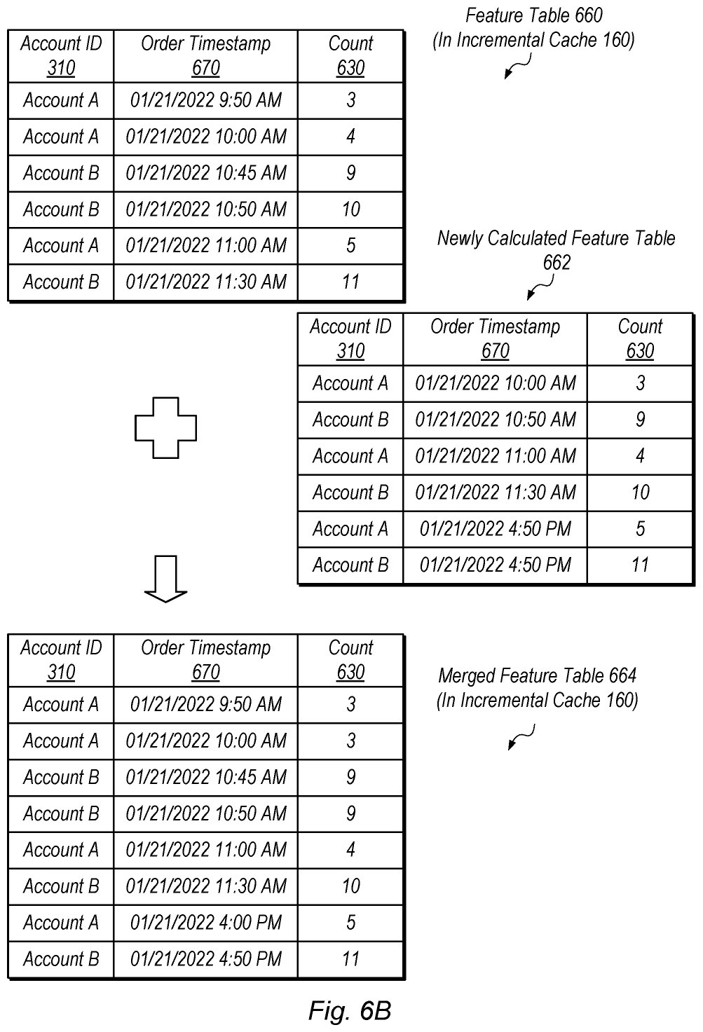

In the illustrated embodiment, server system 120 retrieves source attributes 152 from source database 150. For example, system 120 may retrieve a specific set of source data that includes source attributes 152. These attributes may be for any of various types of source data including, for example, electronic communications (e.g., transactions, messages, etc.), data transmissions for a server network, weather patterns, medical reports, etc. In the example of electronic communication data, source attributes may include values indicating entities involve in the communications, types of information being communicated between entities, amounts of data being communicated (e.g., a transaction amount), etc. Server system 120 inputs source attributes 152 into source checker module 130, which determines a new set 132 of attributes included in source attributes 152 based on a known set of historical attributes. For example, source checker module 130 determines if there has been any new data added to source database 150 (or if existing data has been updated within source database 150 as discussed in further detail below with reference to FIGS. 5-6B).

Feature module 140, in the illustrated embodiment, receives set 132 of new attributes from source checker module 130 and generates a set 142 of new features. For example, feature module 140 executes one or more feature calculation algorithms to calculate new features from the new attributes included in set 132. Example feature calculation algorithms include one or more of the following feature calculation algorithms: summation, count, standard deviation, average, first, last, etc. In some situations, feature calculation algorithms may also include feature preprocessing, such as filtering (e.g., Pearson correlation, chi-squared, etc.), wrapper-based (e.g., recursive feature elimination), embedding (e.g., Lasso, random forest, etc.), or any combination thereof.

Merger module 170, in the illustrated embodiment, is executed by server system 120 to combine the set 142 of new features with one or more existing features 162 retrieved from incremental cache 160. For example, merger module 170 retrieves existing features 162 from incremental cache 160 and executes one or more aggregation procedures to merge new, incremental features with corresponding existing features 162. In various embodiments, server system 120 performs an initial feature calculation based on an initial source dataset (e.g., the first time source data is retrieved from source database 150) to generate existing features 162 and stores them in an empty incremental cache 160. Then, at a later time, server system 120 retrieves source attributes 152 from source database 150 (after new source data is added to source database 150) to calculate new, incremental features.

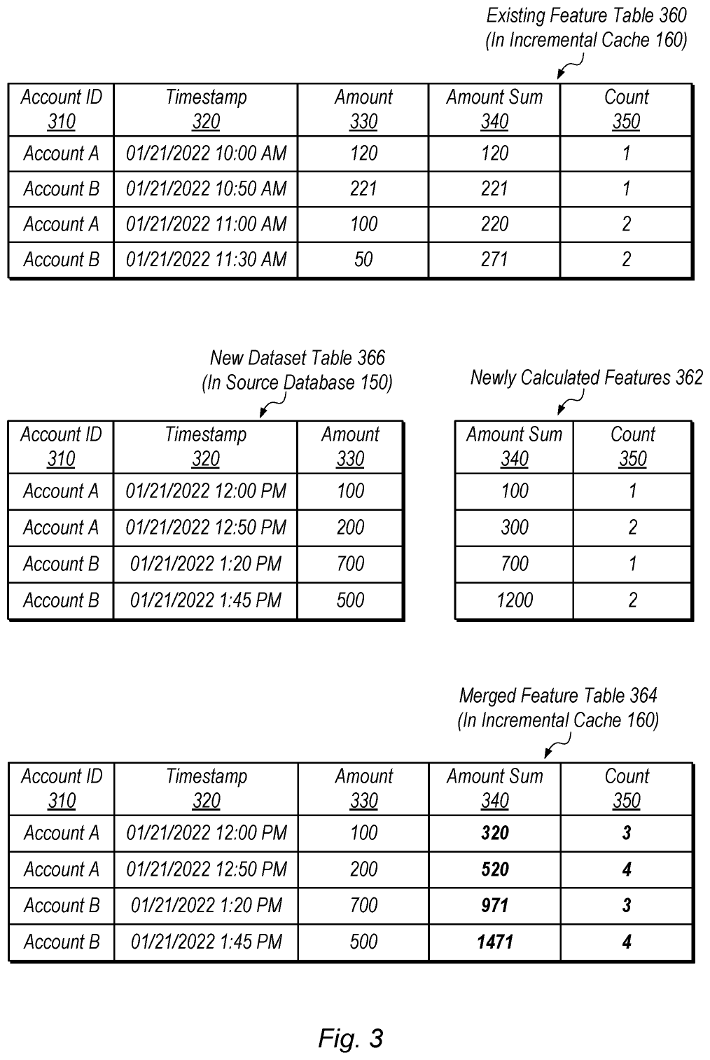

In some embodiments, incremental cache 160 is implemented as a relational database storing tables with various columns for different attributes and features. For example, as shown in FIG. 3, tables 360 and 364 may be stored in the incremental cache and these tables store values for various attributes (e.g., account ID, timestamp, amount, etc.) and various features (e.g., amount sum and count). In some embodiments, the incremental cache stores entries as key-value pairs. For example, merged feature table 364 shown in FIG. 3 may store four rows of information where each row is stored as a key value pair with an account ID (a unique identifier) as the key and the timestamp, amount, amount sum, and count as features (attributes and features for the unique identifier). The incremental cache 160 is implemented such that it is easily queryable. As such, in some embodiments, incremental cache 160 is implemented as one or more tables stored in a relational database and includes one or more indexes that are also stored in the relational database. These indexes are partitioned based on a given timestamp column of the incremental cache 160 table. For example, data stored in the incremental cache 160 is quickly queryable by an entity (e.g., server system 120) using a given timestamp. FIGS. 3, 6A, and 6B illustrate example tables that are included in the incremental cache 160.

In some embodiments, merger module 170 determines which of the new and existing features to combine based on unique keys of these features matching as discussed in further detail below with reference to FIG. 1B. After generating a set 172 of updated (merged) features, merger module 170 stores the set 172 of updated features in incremental cache 160. When storing features in incremental cache 160, the server system 120 stores corresponding unique keys for the features. For example, a user identifier, account identifier, hardware identifier, or any of various information corresponding to the entity for which features are being calculated may be used as a unique feature key. As one specific example, a particular customer may have a primary feature key that is their customer identifier. Examples of merged features stored in incremental cache 160 are discussed in further detail below with reference to FIGS. 3-4B and 6A-6B.

Server system 120, in the illustrated embodiment, receives a request 112 from a user device 110 and inputs this request to accessor module 180. Accessor module 180 retrieves a set 172 of updated (merged) features from incremental cache 160 based on request 112. After retrieving the set 172 of updated features, accessor module 180 performs one or more final feature calculations based on parameters specified in request 112 to generate one or more final features 182. Server system 120 transmits a response 184 to user device 110 that includes the calculated features 182. In some embodiments, user device 110 is a device of a risk analyst that is training one or more machine learning models to automatically predict risk for source data stored in source database 150. For example, an analyst of an electronic processing system that is utilizing user device 110 may request that server system 120 provide a set of features generated from electronic communication source data for use in training (or updating) a machine learning model to detect whether one or more future electronic communications are risky (and potentially malicious) in order to determine whether to approve the future electronic communications.

In this disclosure, various “modules” operable to perform designated functions are shown in the figures and described in detail (e.g., source checker module 130, feature module 140, merger module 170, accessor module 180, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

FIG. 1B is a diagram illustrating an example method for generating updated, final features by merging new features and existing features. The method shown in FIG. 1B may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, server system 120 performs the elements of the method.

In the illustrated embodiment, execution of the method begins at element 102. At element 104, a server system (e.g., server system 120) checks source data to identify whether new data has been added to the source data stored in a source database (e.g., source database 150). In some embodiments, the server system checks the source data for new data or updates based on a triggering event. For example, a triggering event might be: a notification received by the server system from the entity specifying that they have added new source data, a notification received from the source database itself based on the server system placing a monitor (e.g., a binary variable that flips based on changes) on the source database, etc. In other embodiments, the server system checks the source data for new data or updates based on a predetermined check time interval. This predetermined time interval may be set based on an average historical refresh frequency of the source data for a given entity. For example, if a given entity historically stored new source data once a day between 8 AM and 9 AM, then the predetermined check time interval may be set to a 24 hour interval, such that the source data checker is initiated after 9 AM each day.

At element 106, the server system calculates new features from new data identified at clement 104. In the illustrated embodiment, the server system executes merger module 170 to merge new features from the new data 108 and existing features with keys matching the new features 114 (which the server system retrieves from incremental cache 160). For example, the server system executes one or more aggregation procedures to merge new, incremental features with existing features. The one or more aggregation procedures may include one or more of the following: count aggregation (both combination and difference), mean aggregation (both combination and difference), sum aggregation (both combination and difference), average aggregation (both combination and difference), standard deviation (both combination and difference), variance (both combination and difference), maximum (both combination and difference), minimum (both combination and difference), etc.

At element 118, the server system determines whether to replace existing features stored in incremental cache 160 with merged features 116 or to update the incremental cache 160 by adding the merged features as new rows to a feature table stored in the cache 160. For example, at element 122, the server system updates the incremental cache 160 by replacing existing features with merged features 116 based on determining to perform a replacement operation at element 118. In contrast, at element 124, the server system updates the incremental cache 160 by adding rows of merged features to a feature table that stores existing features (as shown in FIG. 6B).

At element 126, the server system receives a request for features that includes one or more parameters specifying limitations for the requested features. For example, the one or more parameters may specify a time interval for which a feature needs to be calculated such as a feature indicating the total electronic communication count for a given entity for two hours prior to a start timestamp. At element 128, the server system queries an incremental cache 160 to retrieve merged features. For example, based on parameters specified in the request received at 126, the server system retrieves features from the incremental cache 160 corresponding to these timestamps. At element 134, the server system calculates final features from the merged features. For example, the server system may need to perform additional calculation on retrieved merged features to generate final features. As one specific example, the request received at 126 may be asking for an electronic communication amount sum feature for all communications occurring two hours prior to a given timestamp, but the incremental cache 160 stores a merged feature indicating the amount sum feature for all communications occurring one hour and three hours prior to the given timestamp. Thus, in this example, the server system must retrieve two different amount sum features, the one calculated for communications occurring one hour prior and the one calculated for communications occurring three hours prior to the given timestamp and then calculate the difference between the two different amount sum features to determine the feature requested at 126.

In various embodiments, the server system 120 calculates different types of features. For example, server system 120 may determine direct features which do not require feature calculations, but may be directly stored by system 120 in incremental cache 160 (e.g., a timestamp is one example of a direct feature). In some embodiments, server system 120 determines aggregated features, including either unbounded or bounded features. For example, an unbounded aggregated feature has no specified time limit, while a bounded aggregated feature includes a specified time limit. An unbounded aggregated feature may be one of three types: one that includes both a specified start and end time (e.g., count for one month that occurs between three and four months ago), one that includes only a start duration (e.g., count since one month ago), and one that includes only an end duration (e.g., count up until two months ago). In some embodiments, after calculating final features from merged features at 134, the server system 120 stores the final features in the incremental cache 160. The storage of final calculated features in incremental cache 160 may advantageously decrease response times for future feature requests.

### Example Aggregation Procedures

Turning now to FIGS. 2A and 2B, block diagrams are shown illustrating example aggregation procedures executed by a merger module. In FIG. 2A, merger module 170 includes count module 210, sum module 220, and mean module 230. While FIG. 2A shows three different example aggregation procedures, merger module 170 may execute any of various different types of aggregation procedures to aggregate different types of features. The aggregation procedures executed by merger module 170 include both combination and difference aggregation procedures. While combination aggregation procedures may be executed for any of various types of features, difference calculations are primarily executed for bounded features. For example, if server system 120 is calculating a total electronic communication count for a given entity for a particular timestamp, there is no difference to be calculated since there is not a start and end timestamp specified (there is not a time interval over which the count is calculated, but rather a single point in time).

Count module 210, in the illustrated embodiment, includes two different count aggregation procedures: a combination count procedure (“combine_count”) and a difference count procedure (“difference_count”). The combination and difference count aggregation procedures both receive the following inputs: count1 (a most recent existing count feature for a key in the incremental cache) and count2 (an incremental count feature for the same key as count1, but calculated from new attributes detected in source data). For example, in order to combine an incremental count feature (count1) with an existing count feature (count2), count module 210 executes the “combine_count” aggregation procedure to add count1 to count2. As discussed in further detail below with reference to FIG. 3, existing counts for two different entities A and B are combined with newly calculated counts for these entities at a more recent time using the “combine_count” aggregation procedure to determine an updated count feature without having to recalculate a total combined count using existing attributes. In addition to executing a combine count procedure, count module 210 may execute a “difference_count” aggregation procedure that determines the difference between an existing count feature (count1) and a new, incremental count feature (count2). In some embodiments, the difference count aggregation procedure determines the difference between an existing count feature (count1) and a new, incremental count feature (count2) by subtracting the existing count feature from the new, incremental count feature.

Similar to count module 210, sum module 220 aggregates existing sum features with new, incremental sum features. For example, sum module 220 may either combine existing and incremental sum features or may determine the difference between existing and incremental sum features. Specifically, the two aggregation procedures executable by sum module 220 receive inputs sum1 (a most recent existing sum feature for a given key in the incremental cache) and sum2 (an incremental sum for the same key as sum1, but calculated from new attributes detected in the source data). For example, the “combine_sum” aggregation procedure adds sum1 to sum2 to determine a combined, current sum feature (a most up-to-date sum feature for both existing and new source data) without having to recalculate the sum1 of existing attributes in the source data. Similarly, sum module 220 may execute a “difference_sum” aggregation procedure to determine the difference between an existing sum feature and a new, incremental sum feature by subtracting sum2 from sum1. In some embodiments, sum module 220 executes a “difference_sum” aggregation procedure that subtracts an existing sum feature from a new, incremental sum feature.

In the illustrated embodiment, merger module 170 further includes mean module 230 which aggregates existing and incremental mean features. For example, mean module 230 includes both a “combine_mean” aggregation procedure and a “difference_mean” procedure. In the illustrated embodiment, the following variables are input to both the combination mean procedure and the difference mean procedure: count1 (the most recent existing count feature for a given key in the incremental cache), count2 (an incremental count feature for the same key as count1 but calculated from new attributes detected in the source data), mean1 (a most recent existing mean feature for a given key in the incremental cache), and mean2 (an incremental mean feature for the same key as mean1, but calculated from new attributes detected in the source data). The “combine_mean” aggregation procedure combines an existing mean feature with a new, incremental mean feature by adding the result of multiplying count1 and count2 with the result of multiplying count2 by mean2 (the new, incremental mean feature). The combine mean aggregation procedure then takes the result of adding these results and divides it by the result of adding count 1 and count 2. In addition, mean module 230 may execute the “difference_mean” aggregation procedure to determine the difference between an existing mean feature and a new, incremental mean feature. For example, the “difference_mean” aggregation procedure subtracts the result of multiplying count2 and mean2 from the result of multiplying count1 and mean1. The “difference_mean” aggregation procedure then divides the result of the subtraction by the result of subtracting count2 from count1.

In FIG. 2B, a continued version of merger module 170 that further includes standard deviation module 240 is shown. For example, merger module 170 may include one or more of count module 210, sum module 220, mean module 230, standard deviation module 240, and any of other various aggregation modules executable to merge existing features with new, incremental features. The standard deviation module 250 shown in FIG. 2B includes both “combine_standard_deviation” and “difference_standard_deviation” aggregation procedures.

In the illustrated embodiment, both the combination and difference aggregation procedures for merging standard deviation features receive the following existing and incremental features are inputs: stddev1 (the most recent existing standard deviation feature for a given key in the incremental cache), cnt1 (an abbreviated version of the feature name count 1 that represents the most recent existing count feature for a given key in the incremental cache), mean1 (the most recent existing mean feature for a given key in the incremental cache), stddev2 (an incremental standard deviation feature for the same key as stddev1, but calculated from new attributes detected in the source data), cnt2 (an abbreviated version of the feature name count2 that represents an incremental count feature for the same key as cnt1, but calculated from new attributes detected in the source data), and mean2 (an incremental mean feature for the same key as mean1, but calculated from new attributes detected in the source data).

The “combine_standard_deviation” aggregation procedure combines an existing standard deviation feature with a newly calculated, incremental standard deviation feature. For example, the combination standard deviation aggregation procedure calculates a final mean from the existing (mean1) and incremental (mean2) mean and the existing (count1) and incremental (count2) count features. The combination standard deviation aggregation procedure further includes calculating an existing variance from the existing standard deviation and an incremental variance from the incremental standard deviation. The combination standard deviation procedure also includes calculating two intermediate variables, q1 and q2 using the calculated variances as shown in FIG. 2B. The intermediate variables q1 and q2 are placeholder variables in this example aggregation procedure. The final calculation performed by the combination standard deviation aggregation procedure includes calculating the square root of the combination of the final mean, the intermediate variables q1 and q2, and the existing and incremental count features.

In contrast, the “difference_standard_deviation” aggregation procedure determines the difference between an existing standard deviation feature and a newly calculated, incremental standard deviation feature. For example, the difference standard deviation procedure includes calculating an intermediate mean variable (intermediateMean), a final variance variable (finalVariance) based on the intermediate mean, and then determining the square root of the final variance variable. The variable squaredSum1 is the sum of the squared value for a key for a start timestamp from the incremental cache. The start timestamp is a point in time at which the feature aggregation begins. For example, in order to determine a transaction count for a given day, Mar. 4, 2023, the start timestamp will be Mar. 3, 2023. The key is the feature key. For example, the feature key may be a customer identifier, an account identifier, a hardware identifier, etc.

### Example Incremental Cache Updates

FIG. 3 is a block diagram illustrating example updating of feature tables stored in an incremental cache. In the illustrated embodiment, an example existing feature table 360 (stored in incremental cache 160 shown in FIG. 1A), a new dataset table 366 (stored in source database 150), a newly calculated features table 362, and a merged feature table 364 (stored in incremental cache 160) are shown.

Existing feature table 360, in the illustrated embodiment, includes an account ID 310 column, a timestamp column 320, an amount 330 column, an amount sum feature 340 column, and a count feature 350 column. The account IDs 310, timestamps 320, and amounts 330 are attributes, while the other columns of table 360 store existing features. The account ID is a unique key representing a given user, the timestamp is a time at which the transaction occurred (e.g., either the time at which the transaction was initiated or the time at which the transaction is complete), the amount is the amount transacted during the transaction (e.g., transferred from one user's account to another user's account), the amount sum is a feature indicating the cumulative sum of the amount per user), and the count is a feature indicating the incremental count of transactions completed by a given user.

The four rows shown in transaction feature table 360 include two entries for account A and two entries for account B. For example, the entries for account A indicate that this account completed transactions for amounts of 120 and 100 at 10:00 AM and 11:00 AM, respectively, on Jan. 21, 2022. Similarly, in this example, the entries for account B indicate that this account completed transactions for amounts 221 and 50 at 10:50 AM and 11:30 AM, respectively, on Jan. 21, 2022. The existing feature table 360 stored in incremental cache 160 also includes an amount sum feature 340 column and a count feature 350 column. For example, the amount sum feature 340 column in table 360 shows an amount sum that is continuously updated, e.g., as account A participates in additional transactions. As one specific example, the amount sum feature 340 for account A changes from 120 to 220 after account A completes the second transaction for amount of 100 (i.e., 120+100). Similarly, the count feature 350 for account A is increased from one to two based on this account completing a second transaction at 11:00 AM on Jan. 21, 2022.

New dataset table 366 stores new attributes for accounts A and B in source database 150. For example, the first and second rows of table 366 store values for attributes corresponding to two different transactions completed for account A. Specifically, the first two rows of table 366 indicate that account A participated in a transaction for an amount of 100 (e.g., US dollars) at 12:00 PM on Jan. 21, 2022 and a transaction for an amount of 200 at 12:50 PM on Jan. 21, 2022. Further, table 366 includes third and fourth rows indicating that account B participated in a transaction for an amount of 700 at 1:20 PM on Jan. 21, 2022 and a transaction for an amount of 500 at 1:45 PM on Jan. 21, 2022.

In addition to the new dataset table 466, the illustrated embodiment shows a set of newly calculated (incremental) features stored in table 362 calculated for accounts A and B, respectively, based on the new data included in table 366. For example, feature module 140 calculates the new incremental features stored in table 362 shown in FIG. 3. In the illustrated embodiment, two new amount sum features 340 are shown for account A (i.e., 100 and 300) and two new amount sum features 340 are shown for account B (i.e., 300 and 1200). Further in this example, two new count features 350 are shown for account A (i.e., 1 and 2) and two new count feature 350 are shown for account B (i.e., 1 and 2). In this example, the count feature 350 for account A increases from 1 to 2 when the second transaction is initiated at timestamp 12:50 PM on Jan. 21, 2022. Similarly, in this example, the amount sum feature 340 for account A increases from 100 to 300 when the second transaction is initiated by account A at timestamp 12:50 PM on Jan. 21, 2022. For example, the amount sum feature 340 for account A is determined by adding the amount 330 attribute for the first and second transactions initiated by account A (i.e., amount sum after the second transaction is calculated by adding 100 and 200).

The merged transaction feature table 364 shown in FIG. 3 stores both existing and merged features for accounts A and B that are stored in incremental cache 160. For example, the first four rows of table 364 store attributes and existing features for four transactions initiated from 10:00 AM to 11:30 AM by accounts A and B on Jan. 21, 2022. The last four rows of table 364 store attributes and merged features for accounts A and B. For example, the fifth row in table 364 includes a merged amount sum feature 340 of 320 and a merged count feature 350 of three. The merged amount sum features shown in table 364 are generated by merger module 170 by merging existing amount sum features shown in table 360 with incremental amount sum features shown in table 362. Similarly, the merged count features shown in table 364 are generated by merger module 170 by merging existing count features shown in table 360 with incremental features included in the newly calculated features stored in table 362.

As discussed above with reference to FIG. 1B, in some embodiments, incremental cache 160 stores both merged features and existing features. For example, in some situations, merged feature table 364 may also include the rows of existing feature table 360 in addition to the four rows of merged features. In the illustrated embodiment, however, rows of merged features are shown without rows of existing features. In various embodiments, merger module 170 generates the merged features shown in FIG. 3 and stored in table 364. For example, merger module 170 generates the merged amount sum feature of 320 for account A at timestamp 12:00 PM by merging the existing amount sum feature of 220 (stored in table 360) with the incremental amount sum feature of 100 (stored in table 362 and corresponding to timestamp 12:00 PM). As another example, merger module 170 generates the merged amount sum feature of 520 for account A at timestamp 12:50 PM by merging the existing amount sum feature of 220 (stored in table 360) with the incremental sum feature of 300 (stored in table 362 and corresponding to timestamp 12:50 PM). Merger module 170 continues this merging process for account B at timestamps 1:20 PM and 1:45 PM as shown by the feature values (for amount sum feature 340 and count feature 350) stored in the last two rows of table 364.

### Example Incremental Cache Accesses

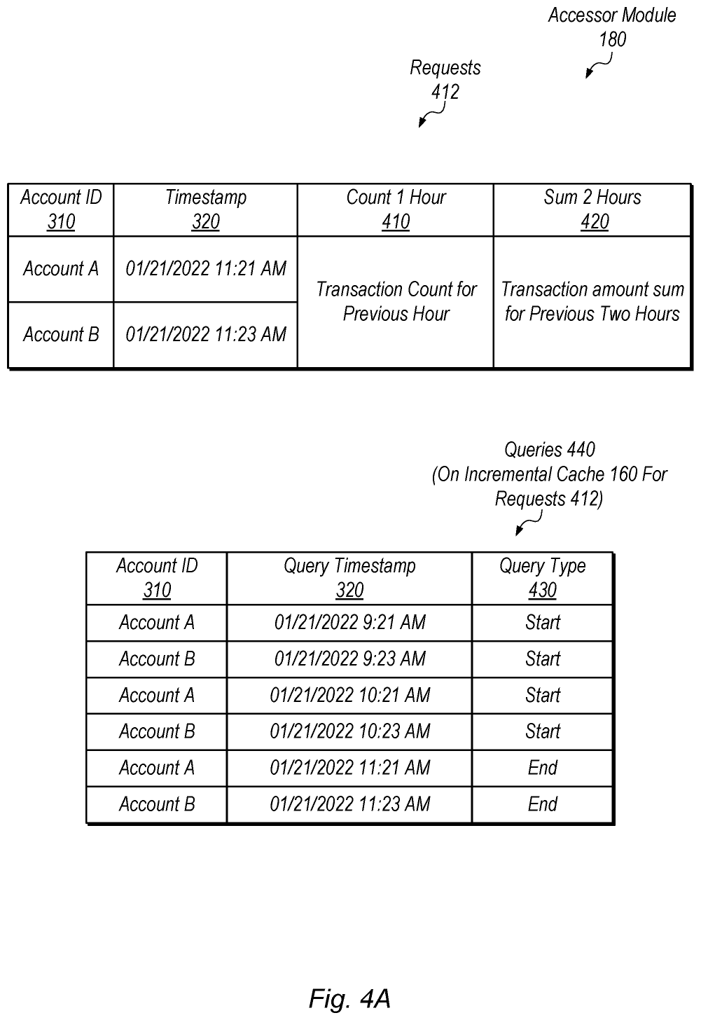

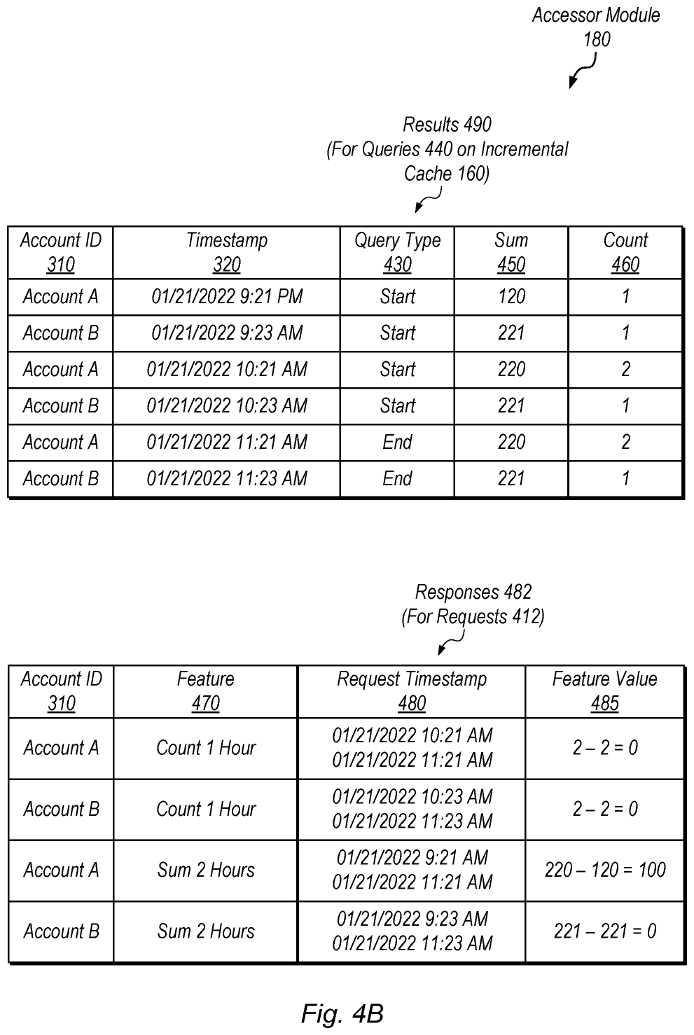

In FIGS. 4A and 4B, block diagrams are shown illustrating example feature requests, feature queries, query results, and responses. In FIG. 4A, example requests 412 received by accessor module 180 of the server system 120 shown in FIG. 1A and example queries 440 generated by accessor module 180 are shown in FIG. 4A. FIG. 4A illustrates example retrieval of features from an incremental cache and calculation of final features based on the retrieved features in order to respond to requests from user devices. In some embodiments, these requests 412 are for features to be fed into a machine learning pipeline. For example, these features may either be used to train a machine learning model or may be fed as input into a trained machine learning model during prediction (e.g., in order to detect suspicious electronic communications).

FIG. 4A illustrates two different example requests 412. The first request is for an account corresponding to account ID 310 “account A,” which requests two different features corresponding to a given timestamp 320 of 11:21 AM on Jan. 21, 2022. The first feature specified in the first request 412 shown in FIG. 4A is a count feature for attributes of account A recorded within a most recent hour occurring prior to the timestamp 11:21 AM on Jan. 21, 2022. The second feature requested in the first request 412 shown in FIG. 4A is a sum feature for attributes recorded for account A within a most recent two hour time interval prior to timestamp 11:21 AM on Jan. 21, 2023. The second request included in FIG. 4A is for account B (an example account ID 310) and requests the same two features, but for time intervals immediately prior to a timestamp 320 of 11:23 AM on Jan. 21, 2022. For example, similar to the first request, the second request 412 shown in FIG. 4A also requests a count feature but determined from attributes recorded for account B within a one hour time window immediately prior to timestamp 11:23 AM on Jan. 21, 2022. The second request also specifies a sum feature determined from attributes recorded for account B within a two hour time window prior to a timestamp of 11:23 AM on Jan. 21, 2022.

In various embodiments, accessor module 180 determines time windows for features specified in requests 412. For example, accessor module 180 determines that the first request 412 is for a count feature for account A for a time interval between 10:21 AM and 11:21 AM on Jan. 21, 2022 and a sum feature for a time interval between 9:21 AM and 11:21 AM on Jan. 21, 2022. Similarly, accessor module 180 determines that the second request is for a count feature for account B for attributes falling within a time interval between 10:23 AM and 11:23 AM on Jan. 21, 2022 and a sum feature for account B for attributes for a time interval between 9:23 AM and 11:23 AM on Jan. 21, 2023.

Queries 440 shown in FIG. 4A are generated by accessor module 180 and are executed on the incremental cache 160 (shown in FIG. 1A) to retrieve features for requests 412. For example, the distinct queries 440 shown in FIG. 4A indicate an account, a query timestamp, and whether this is a start or end type of query. For example, the first query 440 shown in the illustrated embodiment is for account A, specifies a query timestamp of 9:21 AM on Jan. 21, 2022, and is a “start” type of query. A query of “start” type will retrieve records stored in the incremental cache 160 for a specified account with timestamps that are greater than or equal to the query timestamp (i.e., timestamps that are the same time as or later in time than the query timestamp). For example, the first query will retrieve records for account A from the incremental cache with timestamps that are greater than or equal to timestamp 9:21 AM on Jan. 21, 2022. In contrast, a query of “end” type will retrieve records stored in the incremental cache 160 for a specified account with timestamps that are less than or equal to the query timestamp. For example, the fifth query 440 shown in FIG. 4A will retrieve records for account A from the incremental cache with timestamps that are less than or equal to timestamp 11:21 AM on Jan. 21, 2022.

Because the queries 440 shown in FIG. 4A specify multiple different start timestamps, two different sets records will be retrieved from the incremental cache 160 for account A. For example, the first set of records retrieved for account A will include records whose timestamps are greater than or equal to 9:21 AM and less than or equal to 11:21 AM on Jan. 21, 2022. Similarly, in this example, the second set of records retrieved for account A will include records whose timestamps are greater than or equal to 10:21 AM and less than or equal to 11:21 AM on Jan. 21, 2022. That is, the first set of records retrieved for account A will include records whose timestamps fall at or between 9:21 AM and 11:21 AM on Jan. 21, 2022.

FIG. 4B shows a results table 490 of the queries 440 generated and executed by accessor module 180 for requests 412. For example, the first row of the results table 490 includes a sum feature value of 120 and a count feature value of 1 for account A, while the second to last row of table 490 includes a sum feature value of 220 and a count feature value of 2. Similarly, the second row of table 490 includes a sum feature value of 221 and a count feature value of 1 for account B, while the last row of table 490 also includes a sum feature value of 221 and a count feature value of 1.

Based on the results table 490 of queries 440, accessor module 180 generates responses 482 to the requests 412. For example, accessor module 180 performs final feature calculations on one or more features retrieved via queries 440 and included in results table 490. As one specific example, in the illustrated embodiment, the first row of the table showing responses 482 shows a requested count change feature (i.e., count for prior hour for account A beginning at timestamp 11:21 AM on Jan. 21, 2022) and a final feature value 485 calculated by accessor module 180 for the account A In this specific example, the count at 10:21 AM is 2 and the count at 11:21 AM is also 2, so the count change in the last hour is 0. Similarly, the count for account B for the hour prior to timestamp 11:23 AM on Jan. 21, 2022 is 0 (i.e., 2−2=0). In contrast, the amount sum change in the last two hours for account A beginning at timestamp 11:21 AM is a feature of 100 (i.e., 220−120=100).

### Method and Example of Feature Generation for Updated Source Data

Turning now to FIG. 5, a flow diagram is shown illustrating an example method for generating updated features in response to a source dataset being updated, according to some embodiments. The method 500 shown in FIG. 5 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, server system 120 performs the elements of method 500.

At 510, in the illustrated embodiment, a server system retrieves an updated dataset for a current day from a source database (e.g., source database 150 shown in FIG. 1A). The dataset may include a portion of the overall set of source data stored in the source database for a plurality of entities. For example, when existing attributes stored in the source database are updated, the server system detects this update and retrieves the updated attributes from the database.

At 520, the server system retrieves unique keys and minimum created timestamps for features included in the retrieved updated dataset for the current day. For example, a unique key may be a user or account identifier corresponding to a given electronic communication (e.g., electronic transaction). Further in this example, a minimum created timestamp may indicate the time at which an electronic communication is initiated (e.g., the time at which an order is placed). In some embodiments, the minimum created timestamps are indicator attributes for the source data. For example, source data that changes over a given time interval (e.g., a shipment status attribute may be updated multiple times from a time an order is placed until an order is delivered) may include indicator attributes such as a created timestamp and an updated timestamp. These indicator attributes may be stored and updated for this source data entry in the source database 150.

At 530, the server system retrieves data for the unique keys retrieved at 520 as well as their corresponding created timestamps. For example, the server system may first retrieve unique feature keys (e.g., account identifiers) at element 520 and then at element 530, the server system retrieves other attributes and features corresponding to the unique keys. For example, at element 520, the server system retrieves a unique key and a minimum timestamp from the updated dataset. At element 530, in this example, the server system retrieves all other impacted source data that have the same key and a timestamp greater than the corresponding minimum timestamp from the source database. The two different sets of information retrieved at 520 and 530 are needed to recalculate the features and to determine the impact of the updated data on existing features (e.g., by calculating new, incremental features using the disclosed techniques. The retrieved source data may indicate that e.g., an electronic communication has been initiated. In this example, the retrieved source data may also include an updated version of the source data (this data may include an additional indicator timestamp indicating a time at which the source data was updated).

At element 540, the server system retrieves a new dataset for the current day from the source database. For example, the new dataset includes data that did not previously exist and was not previously stored in the source database since the retrievals performed by server system at elements 510-530. As one specific example and as discussed in further detail below with reference to FIGS. 6A and 6B, the new dataset may include new electronic communications initiated by a given user or account. For example, the server system may identify new data based on a known set of existing data previously retrieved by the server system from the source database.

At 550, the server system combines the updated dataset and the new dataset for the current day. For example, the server system may store the new dataset for the current day in a table already storing the updated dataset. The server system then inputs the combined dataset 512 into the feature module 140 which in turn calculates features 514 for the combined dataset using the disclosed feature aggregation procedures as discussed in further detail below with reference to FIGS. 6A and 6B. For example, feature module 140 may calculate features for the new dataset and features for the updated dataset using feature calculation techniques and then merge these two sets of features using the one or more aggregation procedures discussed above with reference to FIGS. 2A and 2B. The server system stores the calculated features 514 in the incremental cache 160.

The server system performs method 500 in order to identify whether existing attributes included in source data have been updated since the time at which they were created. For example, the server system identifies, based on an indicator attribute stored in the source data whether a non-indicator attribute has been updated. In this example, the indicator attribute may be a status attribute e.g., indicating whether a status corresponding to a non-indicator attribute has changed (has been updated). When the server system identifies that an attribute has been updated based on its corresponding indicator attribute, the server system retrieves the updated attribute in order to calculate incremental features for merge with existing features corresponding to the existing attributes (the attributes prior to the updates).

In some embodiments, the server system implements incremental cache 160 based on different storage requirements corresponding to different features. For example, features stored in incremental cache 160 for a first entity may have a max storage requirement that is greater than a storage requirement for features stored in the cache for a second, different entity. As one specific example, if a maximum storage time for a given entity is six months, then the server system will evict features for this entity from the incremental cache 160 after they have been stored for six months. In other situations, server system stores features in incremental cache 160 indefinitely. In some embodiments, in addition to generating and storing calculated features 514 for a combined dataset 512 in incremental cache, the server system performs additional processing on the features. For example, the server system may determine whether additional merges, approximations, or processing may be performed on the calculated features 514. As one specific example, the server system may merge three rows of features stored in incremental cache 160 to simplify and decrease the amount of space utilized to store features for a given entity. In this example, the server system may merge three different total active shipment count features having timestamps between 9:52 AM and 11:00 AM together to generate a condensed total active shipment count feature e.g., for a given account.

FIGS. 6A and 6B are block diagrams illustrating example merged features generated based on a source dataset being updated. In FIG. 6A a table 660 storing values for existing features (stored in incremental cache 160) and a table 652 storing both updated and new source attributes (stored in source database 150) are shown. The example illustrated and discussed below with reference to FIGS. 6A and 6B corresponds to situations in which the disclosed feature merger system handles updates to existing source data. As one specific example, existing source data may include a shipment status feature which has a first value of “active” when initiated, but which is updated over time to “in-transit,” “complete,” “lost,” etc. over time.

In the illustrated embodiment, table 660 includes three columns: account ID 310 (a unique key representing a given user or account), order timestamp 670 (the time at which the order was placed), and existing count feature 630 (the total number of orders for this account where the shipment status is currently set to “active”). The rows of table 660 include values for these three columns. For example, the first row of table 660 includes an entry for an order with an account ID of account A, an order timestamp of Jan. 21, 2022 9:50 AM, and a count feature of 3. The second row of table 660 shows that at 10:00 AM on Jan. 21, 2022 after 10 minutes has passed, account A now has an order count of 4 (this account has initiated a new order whose shipment status is currently set to “active”). The entries of table 660 for account B indicate that this account initiates two new orders between 10:45 AM and 11:30 AM, increasing its total “active” order count from 9 to 11.

Table 652, in the illustrated embodiment, includes two entries with updated attributes and four new entries with new attributes. The first four columns of table 652 store values for existing attributes for various orders placed by accounts A and B indicating the account, order timestamp 670 (the time at which the order was placed), the status 680 (the current shipment status), and the created timestamp 672 (the time at which the label for the order was printed). For example, the first row in table 652 stores five existing attributes and an updated attribute for a given order placed by account A on Jan. 21, 2022 at 10:00 AM. The first row also includes an updated timestamp 674 (an indicator attribute), in addition to an order and created timestamp, which indicates that the status of this order was updated at 4:42 PM on Jan. 21, 2022 e.g., from “active” to “done.” The last four rows of table 652 do not include values for the updated timestamp 674 indicator attribute since these orders have not been updated since conception (e.g., these orders have a status 680 attribute value of “active”).

In FIG. 6B, the same table 660 shown in FIG. 6A storing existing features in incremental cache 160 is shown. In addition, in the illustrated embodiment, a table 662 storing newly calculated features (calculated based on the updated and new attributes stored in table 652) is shown as well as a table 664 storing merged features (generated by merging existing features stored in table 660 and new features stored in table 662).

In the illustrated embodiment, table 662 includes six rows storing a count feature 630 for accounts A and B at different times on Jan. 21, 2022. For example, the first row of table 662 indicates that account A has a count feature of 3 at 10:00 AM on Jan. 21, 2022 indicating that this account currently has three active orders. Similarly, the count feature value of 9 stored in the second row of table 662 for account B indicates that this account has nine active orders at 10:50 AM on Jan. 21, 2022. Further, table 662 indicates that at 4:50 PM the same day, account B now has eleven active orders according to the count feature 630 column. The values stored in table 662 for the count feature 630 are calculated by feature module 140 based on the updated timestamps 674 and the status 680 stored in table 652. For example, if the shipment status of a given order is “active,” then feature module 140 will add one to the previous count feature 630 value for the account corresponding to this order; otherwise, feature module 140 returns the previous count feature 630 value for this account (i.e., if the shipment status for this order is “done”). In some embodiments, after calculating the new features shown in table 662, the server system stores the newly calculated features in a new table in the incremental cache 160. In other embodiments, the server system updates the incremental cache 160 by merging the newly calculated features with the existing features of table 660 to generate an updated, merged table 664 within incremental cache 160.

### Example Method

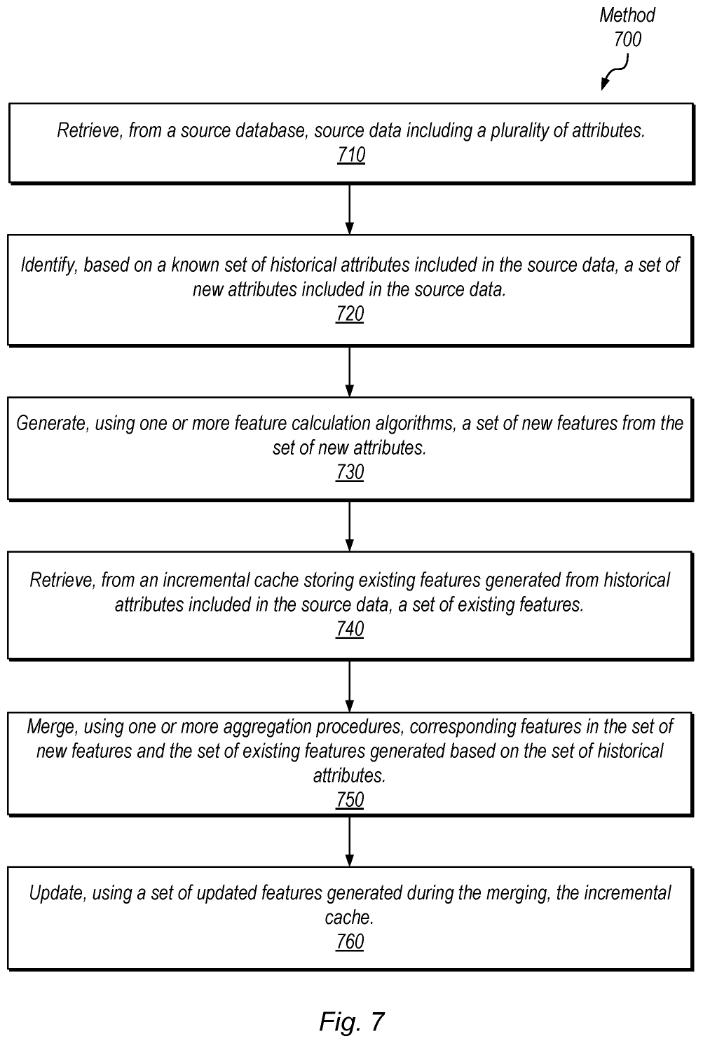

FIG. 7 is a flow diagram illustrating a method for merging new and existing features and updating an incremental cache using merged features, according to some embodiments. The method 700 shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, server system 120 performs the elements of method 700.

At 710, in the illustrated embodiment, a server system retrieves, from a source database, source data including a plurality of attributes. In some embodiments, server system 120 executes source checker module 130 to monitor and retrieve source data from source database 150 as discussed above with reference to FIG. 1A. In some embodiments, the source database stores source data for a plurality of different entities. In some embodiments, the retrieving from the source database is performed at a first timestamp, where the set of existing features include at least a start timestamp and an end timestamp indicating that the set of existing features were generated during a time interval that is prior to the first timestamp and that is from the start timestamp to the end timestamp. In some embodiments, the end timestamp is closer in time to the first timestamp than the start timestamp, where the set of updated features includes features with timestamps from the start timestamp to the first timestamp.

At 720, the server system identifies, based on a known set of historical attributes included in the source data, a set of new attributes included in the source data. In some embodiments, server system 120 executes source checker module 130 to identify new source attributes as discussed above with reference to FIG. 1A. In some embodiments, identifying the set of new attributes included in the source data for merging further includes identifying, by the server system based on an indicator attribute stored in the source data and corresponding to a non-indicator attribute, that the non-indicator attribute has been updated. In some embodiments, identifying the set of new attributes included in the source data for merging further includes adding the updated, non-indicator attribute to the set of new attributes.

At 730, the server system generates, using one or more feature calculation algorithms, a set of new features from the set of new attributes. In some embodiments, server system 120 executes feature module 140 to generate a new set of features as discussed above with reference to FIGS. 1A, 3, and 5. In some embodiments, the set of new features includes one or more types of the following types of features: a direct feature that is a copy of a corresponding attribute, an aggregated feature that is derived from multiple attributes, an unbounded feature that is not bound by a time limitation, and a bounded feature that corresponds to a specified time range.

At 740, the server system retrieves, from an incremental cache storing existing features generated from historical attributes included in the source data, a set of existing features. In some embodiments, server system 120 executes merger module 170 to retrieve existing features 162 as discussed above with reference to FIG. 1A.

At 750, the server system merges, using one or more aggregation procedures, corresponding features in the set of new features and the set of existing features generated based on the set of historical attributes. In some embodiments, server system 120 executes merger module 170 to merge existing and new, incremental features using one or more aggregation procedures as discussed above with reference to FIGS. 1A-2B. In some embodiments, the merging of a given type of feature from the set of new features and the set of existing features is performed based on identifying that the two features of the given type of feature have the same unique feature key. In some embodiments, the merging performed by server system results in a set of combined features. In some embodiments, the set of combined features includes one of more types of the following types of bounded features that are limited by a specific time range: a bounded feature that includes both a start and end time duration, a bounded feature that includes only a start time duration, and a bounded feature that includes only an end time duration.

In some embodiments, the one or more aggregation procedures include a mean combination aggregation procedure that includes generating a first value and dividing the first value by the sum of a first count and a second count. In some embodiments, generating the first value for the mean combination procedure includes multiplying a first count and a first mean, multiplying a second count and a second mean, and adding a result of multiplying the first count and the first mean to a result of multiplying the second count and the second mean. In some embodiments, the one or more aggregation procedures include a mean aggregation procedure that includes generating a first value, generating a second value by subtracting the second count from the first count, and dividing the first value by the second value. In some embodiments, generating the first value for the mean difference aggregation procedure includes multiplying a first count and a first mean, multiplying a second count and a second mean, and subtracting a result of multiplying the first count and the first mean from a result of multiplying the second count and the second mean. In some embodiments, the one or more aggregation procedures include a count combination aggregation procedure, where executing the count combination aggregation procedure includes combining a first count and a second count. In some embodiments, the first count is an existing feature and the second count is a new feature.

In some embodiments, the one or more aggregation procedures include a standard deviation combination aggregation procedure, where executing the standard deviation combination aggregation procedure to combine two or more standard deviation features includes determining an overall mean. In some embodiments, determining the overall mean includes multiplying a first count by a first mean and a second count by a second mean and dividing a result of the multiplication by the combination of the first count and the second count. In some embodiments, determining the overall mean further includes determining a first variance by squaring a first standard deviation, determining a second variance by squaring a second standard deviation, generating a first value, and generating a second value. In some embodiments, generating the first value includes: multiplying the first variance by the result of subtracting one from the first count and multiplying the first count by the first mean squared. In some embodiments, generating the second value includes multiplying the second variance by the result of subtracting one from the second count and multiplying the second count by the second mean squared. In some embodiments, executing the standard deviation combination aggregation procedure further includes determining the square root of a final value. In some embodiments, the final value is generated by: adding the first value and the second value, adding the first count and the second count, generating a third value by multiplying the result of adding the first count and the second count by the overall mean squared, generating a fourth value by subtracting the third value from the result of adding the first value and the second value, generating a fifth value by subtracting one from the sum of the first count and the second count, and dividing the fourth value by the fifth value.

In some embodiments, the one or more aggregation procedures include a standard deviation difference aggregation procedure. In some embodiments, the standard deviation difference aggregation procedure includes determining an overall mean by: generating a first value by subtracting a second sum by a first sum, generating a second value by subtracting a second count from a first count, determining a final mean by dividing the first value by the second value, determining a final variance, and determining the square root of the final variance. In some embodiments, determining the final variance includes: generating a third value by multiplying two by the final mean and the first value, generating a fourth value by multiplying the final mean squared by a result of subtracting the first count from the second count, generating a fifth value by subtracting the second sum squared from the first sum squared, adding the third value, fourth value and fifth value, and dividing a result of the adding by the second value.

At 760, the server system updates, using a set of updated features generated during the merging, the incremental cache. In some embodiments, server system updates the incremental cache 160 discussed above with reference to FIGS. 1A and 1B based on output of merger module 170. In some embodiments, the server system receives, from a user computing device, a request for one or more features. In some embodiments, the server system accesses, based on the request, the incremental cache to retrieve one or more features. In some embodiments, the server system generates, based on one or more parameters specified in the request and the one or more features retrieved from the incremental cache, a set of preprocessed features for the request. In some embodiments, the server system transmits the set of preprocessed features to the user computing device. In some embodiments, prior to transmitting the set of preprocessed features, the server system trains, using the set of preprocessed features, a machine learning model, where the machine learning model is trained to classify electronic communications according to the training using set of preprocessed features generated by the server system from source data for a plurality of previous electronic communications for which a classification is known.

### Example Computing Device

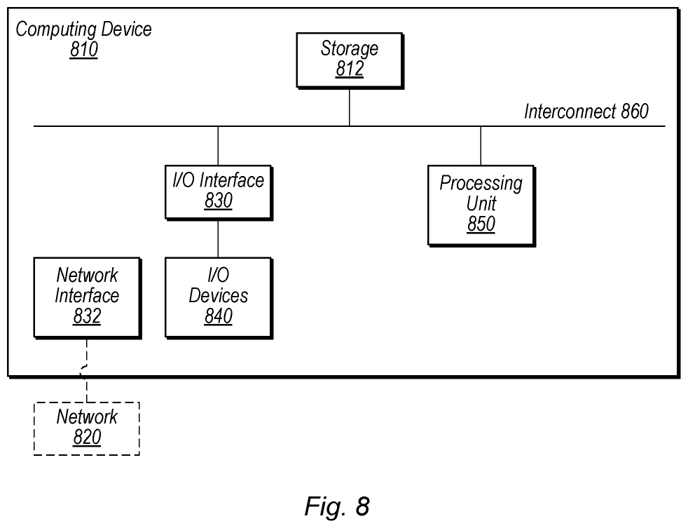

Turning now to FIG. 8, a block diagram of one embodiment of computing device 810 (which may also be referred to as a computing system) is depicted. Computing device 810 may be used to implement various portions of this disclosure. Computing device 810 may be any suitable type of device, including, but not limited to, a personal computer system, desktop computer, laptop or notebook computer, mainframe computer system, web server, workstation, or network computer. The server system 120 shown in FIG. 1A and discussed above is one example of computing device 810. As shown, computing device 810 includes processing unit 850, storage 812, and input/output (I/O) interface 830 coupled via an interconnect 860 (e.g., a system bus). I/O interface 830 may be coupled to one or more I/O devices 840. Computing device 810 further includes network interface 832, which may be coupled to network 820 for communications with, for example, other computing devices.

In various embodiments, processing unit 850 includes one or more processors. In some embodiments, processing unit 850 includes one or more coprocessor units. In some embodiments, multiple instances of processing unit 850 may be coupled to interconnect 860. Processing unit 850 (or each processor within 850) may contain a cache or other form of on-board memory. In some embodiments, processing unit 850 may be implemented as a general-purpose processing unit, and in other embodiments it may be implemented as a special purpose processing unit (e.g., an ASIC). In general, computing device 810 is not limited to any particular type of processing unit or processor subsystem.

Storage subsystem 812 is usable by processing unit 850 (e.g., to store instructions executable by and data used by processing unit 850). Storage subsystem 812 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 812 may consist solely of volatile memory, in one embodiment. Source database 150, discussed above with reference to FIG. 1A is one example of storage subsystem 812. Storage subsystem 812 may store program instructions executable by computing device 810 using processing unit 850, including program instructions executable to cause computing device 810 to implement the various techniques disclosed herein.

I/O interface 830 may represent one or more interfaces and may be any of various types of interfaces configured to couple to and communicate with other devices, according to various embodiments. In one embodiment, I/O interface 830 is a bridge chip from a front-side to one or more back-side buses. I/O interface 830 may be coupled to one or more I/O devices 840 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

What is claimed is:

1. A method, comprising:
retrieving, by a server system from a source database, source data including a plurality of attributes;
identifying, by the server system based on a known set of historical attributes included in the source data, a set of new attributes included in the source data;
generating, by the server system using one or more feature calculation algorithms, a set of new features from the set of new attributes;
retrieving, by the server system from an incremental cache storing existing features generated from historical attributes included in the source data, a set of existing features;
merging, by the server system using one or more aggregation procedures, corresponding features in the set of new features and the set of existing features generated based on the set of historical attributes; and
updating, by the server system using a set of updated features generated during the merging, the incremental cache.

2. The method of claim 1, further comprising:
receiving, by the server system from a user computing device, a request for one or more features;
accessing, by the server system based on the request, the incremental cache to retrieve one or more features;
generating, by the server system based on one or more parameters specified in the request and the one or more features retrieved from the incremental cache, a set of preprocessed features for the request; and
transmitting, by the server system to the user computing device, the set of preprocessed features.

3. The method of claim 2, further comprising, prior to transmitting the set of preprocessed features:
training, by the server system using the set of preprocessed features, a machine learning model, wherein the machine learning model is trained to classify electronic communications according to the training using set of preprocessed features generated by the server system from source data for a plurality of previous electronic communications for which a classification is known.

4. The method of claim 1, wherein the one or more aggregation procedures include a mean combination aggregation procedure, and wherein executing the mean combination aggregation procedure includes:
generating a first value by adding results of:
multiplying a first count and a first mean;
multiplying a second count and a second mean; and
adding a result of multiplying the first count and the first mean to a result of multiplying the second count and the second mean; and
dividing the first value by the sum of the first count and the second count.

5. The method of claim 1, wherein the one or more aggregation procedures include a mean difference aggregation procedure, and wherein executing the mean difference aggregation procedure includes:
generating a first value by adding results of:
multiplying a first count and a first mean;
multiplying a second count and a second mean; and
subtracting a result of multiplying the first count and the first mean from a result of multiplying the second count and the second mean; and
generating a second value by subtracting the second count from the first count; and
dividing the first value by the second value.

6. The method of claim 1, wherein the retrieving from the source database is performed at a first timestamp, wherein the set of existing features include at least a start timestamp and an end timestamp indicating that the set of existing features were generated during a time interval that is prior to the first timestamp and that is from the start timestamp to the end timestamp, wherein the end timestamp is closer in time to the first timestamp than the start timestamp, and wherein the set of updated features includes features with timestamps from the start timestamp to the first timestamp.

7. The method of claim 1, wherein identifying the set of new attributes included in the source data for merging further includes:
identifying, by the server system based on an indicator attribute stored in the source data and corresponding to a non-indicator attribute, that the non-indicator attribute has been updated; and
adding the updated, non-indicator attribute to the set of new attributes.

8. The method of claim 1, wherein the merging a given type of feature from the set of new features and the set of existing features is performed based on identifying that two features of the given type of feature from the set of new features and the set of existing features have the same unique feature key.

9. The method of claim 1, wherein the set of new features includes one or more types of the following types of features: a direct feature that is a copy of a corresponding attribute, an aggregated feature that is derived from multiple attributes, an unbounded feature that is not bound by a time limitation, and a bounded feature that corresponds to a specified time range.

10. A non-transitory computer-readable medium having instructions stored thereon that are executable by a server system to perform operations comprising:
retrieving, from a cache database, a set of historical features calculated from a historical set of source attributes;
retrieving, from a source database, source data including a plurality of attributes;
identifying, based on the historical set of source attributes included in the source data, a set of new attributes included in the source data;
generating, using one or more feature calculation algorithms, a set of new features from the set of new attributes;
merging, using one or more aggregation procedures, corresponding features in the set of new features and the set of historical features retrieved from the cache database, wherein the merging is performed to generate a set of updated features without recalculating features in the set of existing features from the set of historical attributes; and
storing the set of updated features in the cache database.

11. The non-transitory computer-readable medium of claim 10, wherein the operations further comprise:
receiving, from a user computing device, a request for one or more features;
generating, based on one or more parameters specified in the request and the one or more features retrieved from the cache database, a set of preprocessed features for the request; and
transmitting, to the user computing device, the set of preprocessed features.

12. The non-transitory computer-readable medium of claim 10, wherein the operations further comprise:
generating based on one or more features retrieved from the cache database, a set of preprocessed features; and
training, using the set of preprocessed features, a machine learning model, wherein the machine learning model is trained to classify electronic communications according to the set of preprocessed features generated by the server system from source data for a plurality of previous electronic communications for which a classification is known.

13. The non-transitory computer-readable medium of claim 10, wherein the one or more aggregation procedures include a count combination aggregation procedure, wherein executing the count combination aggregation procedure includes combining a first count and a second count, and wherein the first count is an existing feature and the second count is a new feature.

14. The non-transitory computer-readable medium of claim 10, wherein the one or more aggregation procedures include a standard deviation combination aggregation procedure, wherein executing the standard deviation combination aggregation procedure to combine two or more standard deviation features includes determining an overall mean by:
multiplying a first count by a first mean and a second count by a second mean;
dividing a result of the multiplication by the combination of the first count and the second count;
determining a first variance by squaring a first standard deviation;
determining a second variance by squaring a second standard deviation;
generating a first value by adding the results of:
multiplying the first variance by the result of subtracting one from the first count; and
multiplying the first count by the first mean squared;
generating a second value by adding the results of:
multiplying the second variance by the result of subtracting one from the second count; and
multiplying the second count by the second mean squared.

15. The non-transitory computer-readable medium of claim 14, executing the standard deviation combination aggregation procedure further includes determining the square root of a final value generated by:
adding the first value and the second value;
adding the first count and the second count;
generating a third value by multiplying the result of adding the first count and the second count by the overall mean squared;
generating a fourth value by subtracting the third value from the result of adding the first value and the second value;
generating a fifth value by subtracting one from the sum of the first count and the second count; and
dividing the fourth value by the fifth value.

16. A system comprising:
a processor; and
a non-transitory computer-readable medium having stored thereon instructions that are executable by the processor to cause the system to perform operations comprising:
retrieving, from a source database, source data including a plurality of attributes;
identifying, based on a set of historical attributes included in the source data, a set of new attributes included in the source data;
generating, using one or more feature calculation algorithms, a set of new features from the set of new attributes;
retrieving, from an incremental cache storing existing features generated from historical attributes included in the source data, a set of existing features;
combining, using one or more aggregation procedures, corresponding features in the set of new features and the set of existing features generated based on the set of historical attributes; and
updating, using a set of combined features generated by the combining, the incremental cache, wherein the updating includes adding rows of the combined features in the set of combined features to a feature table in the incremental cache storing existing features.

17. The system of claim 16, wherein the instructions are executable by the processor to cause the system to perform further operations comprising:
receiving, from a user computing device, a request for one or more features;
generating, based on one or more parameters specified in the request and the one or more features retrieved from the incremental cache, a set of preprocessed features for the request; and
transmitting, to the user computing device, the set of preprocessed features.

18. The system of claim 16, wherein the set of combined features includes one of more types of the following types of bounded features that are limited by a specific time range: a bounded feature that includes both a start and end time duration, a bounded feature that includes only a start time duration, and a bounded feature that includes only an end time duration.

19. The system of claim 16, wherein the one or more aggregation procedures include a mean aggregation difference procedure, wherein executing the mean difference aggregation procedure includes:
generating a first value by adding results of:
multiplying a first count and a first mean;
multiplying a second count and a second mean; and
subtracting a result of multiplying the first count and the first mean from a result of multiplying the second count and the second mean; and
generating a second value by subtracting the second count from the first count; and
dividing the first value by the second value.

20. The system of claim 16, wherein the one or more aggregation procedures include a standard deviation difference aggregation procedure, and wherein the standard deviation difference aggregation procedure includes determining an overall mean by:
generating a first value by subtracting a second sum by a first sum;
generating a second value by subtracting a second count from a first count;
determining a final mean by dividing the first value by the second value;
determining a final variance by:
generating a third value by multiplying two by the final mean and the first value;
generating a fourth value by multiplying the final mean squared by a result of subtracting the first count from the second count;
generating a fifth value by subtracting the second sum squared from the first sum squared;
adding the third value, fourth value and fifth value; and
dividing a result of the adding by the second value; and
determining the square root of the final variance.
